(19) United States
(12) Patent Application Publication
(10) Pub. No.: US 2013/0327719 A1
(43) Pub. Date: Dec. 12, 2013

(54) APPARATUS AND METHOD FOR AUTOMATED LUBRICATION OIL FILTRATION AND TESTING

(71) Applicant: William J. Van Ee, Cincinnati, OH (US)

(72) Inventor: William J. Van Ee, Cincinnati, OH (US)

(21) Appl. No.: 13/912,083

(22) Filed: Jun. 6, 2013

Related U.S. Application Data
(60) Provisional application No. 61/656,202, filed on Jun. 6, 2012.

(51) Int. Cl. B01D 35/00

(52) U.S. Cl. CPC B01D 35/005
USPC 210/742; 210/184; 210/149; 210/96.1; 210/774

(57) ABSTRACT

An automated lubrication oil filtration device including an oil pump adapted to transfer a lubrication oil from an engine to an oil reservoir, an oil heater associated with the oil reservoir and adapted to increase a temperature of the lubrication oil, a filter pump adapted to transfer the lubrication oil from the oil reservoir through a filtering device and return the lubrication oil to the oil reservoir, and a programmable logic controller adapted to control operation of the oil pump, the oil heater, and the filter pump. The oil heater maintains the temperature of the lubrication oil at a desired temperature.

### CROSS-REFERENCE TO RELATED APPLICATIONS

This application claims the benefit under 35 U.S.C. §119(e) of U.S. Provisional Application No. 61/656,202, filed Jun. 6, 2012.

### INCORPORATION BY REFERENCE

The following patents are incorporated herein by reference in their entireties: U.S. Pat. No. 6,510,736, issued on Jan. 28, 2003, U.S. Pat. No. 6,931,926, issued on Aug. 23, 2005, and U.S. Pat. No. 7,895,890, issued on Mar. 1, 2011.

The following non-patent publications are incorporated herein by reference in their entireties:
Rob Simmonds, It's All About Size, Practicing Oil Analysis Magazine, January 2007.
Jim Fitch, Determining Proper Oil and Filter Change Intervals: Can Onboard Automotive Sensors Help?, Practicing Oil Analysis Magazine, January 2004.
William G. Forbes, Lubrication of Industrial and Marine Machinery, 1943.
California Department of Toxic Substances Control, Evaluation of High Efficiency Oil Filters in the State Fleet, June 2008 (Publication Number IWMB-2008-020).
Jose Paramo, Systematic Oil Analysis Interpretation, Practicing Oil Analysis Magazine September 2006.
Gerardo Trujillo, Blotter Spot Test Helps Improve Engine Reliability, Practicing Oil Analysis Magazine, July 2003.

### TECHNICAL FIELD

The invention relates generally to a device for filtering and/or removing contaminants from lubrication oil and for testing and assessing the condition of lubrication oil.

### BACKGROUND

With very few exceptions, the existing method for maintaining lubricants used in internal combustion (IC) engines is through the outdated preventive maintenance practice of periodically “changing” both oil filters and lubricating fluids based on miles or hours of use. This method is both wasteful and outdated because it does not take into account the actual condition of the lubricant. In the few cases where the proactive maintenance (PaM) method has proven to be successful, it is based upon the lubricant being tested at an off-site lab which makes it impractical for all but continuous use types of machines.

For over 80 years, many devices and methods have been developed to extend the useful life of IC engine lubrication oil. The periodic “oil change” coupled with the use of full flow filters on each engine has emerged as the accepted practice. This filtration system can be defined as one that requires the entire flow from the oil pump to pass through the filter element. To enable full flow filtration to occur, a surface type filter media is employed. Surface type filters work by direct interception of particles larger than the pore size of the media. Dirt is trapped on the upstream side of the media, with the holding capacity limited by the number of media pores. When new, media resistance to flow is small, but as the filter builds up with contaminants, the resistance to flow rapidly increases. This method of filtration typically removes particulate contaminants down to approximately 40 μm “microns” (0.0013 inches). The advantage to this type of filtration is that it is inexpensive, and works reasonably well when the filter element and lubrication oil are changed on a relatively short periodic basis of approximately every 3,000 to 5,000 miles. The disadvantages are that most of the damage done to an IC engine is by particles ranging in size from 2 μm to 20 μm, and that the lubrication oil must be replaced prematurely not because it is truly unusable, but because the filtration process is inadequate. See, Simmonds.

Another method has evolved known as the “By-Pass” or “High Efficiency Oil Filter” (HEOF) method and has gained acceptance as a “Standard Practice” in continuous use engine applications. This method, until now, has been accomplished only through the addition of this type of filtration system to the existing full flow filtration system on each vehicle or engine and then combined with periodic sampling and laboratory testing to determine continued usability of the lubrication oil. The type of filter element used in this process is known as a “Depth Type Filter Element.” Depth type filters work by both direct interception of particles and absorption (molecular attraction of particles). These filters use several types of media to achieve the goal of holding particles. The fluid must take a longer path through and by the filter before exiting. Normally, these filters have large holding capacities and initially have a higher resistance to flow which for the most part makes them unsuitable for use in full flow applications. However they are quite effective when used in a “By-Pass” mode of operation, hence they are also known as “By-Pass Filters” or “Partial Flow Filters.”

The maintenance approach that employs a “By-Pass” or “High Efficiency Oil Filter” (HEOF) element is commonly referred to as a “Proactive Maintenance” (PaM) approach. This method has been found to be very effective for continuous use applications but not so for intermittent use applications, such as school busses and delivery vehicles, because of its high cost.

The primary function of a lubricant is to provide a film, sometimes referred to as an elastohydrodynamic (EHD) film, between the moving parts of the machine. An internal combustion engine has many components requiring this type of lubrication, including crankshaft bearings, camshaft bearings, cylinder bores, piston rings, and others. Since the invention of the IC engine there has been a need to maintain the lubricants used in them. Unlike many lubricant applications, IC engines impose numerous demands on their lubrication oils in addition to lubricating. The lubrication oil is used as a coolant, a medium for transporting solid and liquid contaminants away from cylinder bores, a means of distributing additives to engine surfaces, and other functions, in addition to its primary function of lubricating.

Two established practices regarding the “maintenance” of these lubricants have now become major barriers to reducing them as a source of waste and pollution. The first started in the 1900s with the widespread use of the IC engine and is known as the “fixed change interval.” In this practice lubrication oil is drained or changed on a fixed periodic basis of hours or miles of use. The second outdated practice is called the “Full Analysis” testing practice, where every sample of in-use lubrication oil was subjected to a number of laboratory tests to determine continued usability. There were good reasons for the practice of the “fixed drain interval”:
1. Lubrication oil was cheap;
2. The physical properties of the lubrication oil broke down much faster than today's lubricants;
3. The lubrication oil became contaminated much faster because filters were not commonly used, if at all;
4. Acceptable contaminant levels in lubrication oil were not known because lubrication oil analysis was non-existent or in its absolute infancy; and
5. There was little concern over the polluting effects of disposing of used lubrication oil directly back into the environment.

80 years later, lubricant suppliers still whole-heartedly embrace the practice of the fixed drain interval because of the revenue generated. It was estimated that between 300 million and 400 million gallons of engine lubrication oil were consumed unnecessarily in the United States (worth about $1.5 billion in 2004 dollars not including labor) because of inappropriate drain intervals. See, Fitch. The price of crude oil has doubled since then from $40-$50/Bbl. to the present price of $90-$100/Bbl., the number of vehicles has increased, in many places, there are now additional disposal costs, and the inflation of the U.S. dollar has also increased the overall cost. If the cost of labor were to be included, it can be estimated with some confidence that the overall costs would have doubled to over $3.0 billion dollars by now. It is easy to see why lubrication oil suppliers defend this outdated practice. And these costs in no way reflect the cost of the damage to the environment caused by this outdated practice.

There were also good reasons for the “Full Analysis” testing practice:
1. There was not an accepted single test to determine a lubricant's continued usability;
2. The established practice of laboratory based multiple tests became firmly established;
3. There is no incentive for testing laboratories to streamline or improve their testing procedures;
4. Lubricant suppliers realize that the more expensive, time consuming, and complex, the testing procedure is, the less likely the consumer will use a proactive maintenance approach to their lubrication needs so they certainly are not interested in an improved testing method; and
5. It is certainly not in an engine manufacturer's best interest to embrace a better method for determining lubrication oil quality. An improved testing method would eliminate several key sources of revenue for these manufacturers including: engine replacements and overhauls, aftermarket replacement parts sales, oil filters, their own lubrication oil testing services, and the sale of numerous other services.

A documented historical record can be found in the “Lubrication of Industrial and Marine Machinery.” See, Forbes. Under a section entitled “Diesel Engines: Analysis of used Crankcase Oils” between six and seven tests were required to analyze in-use diesel engine lubrication oil. Id. These tests would be known today by other names because the methods used to perform the analysis have changed significantly but the properties being tested remain unchanged. By today's names these properties are known as: Viscosity, Total Acid Number (TAN), or Total Base Number (TBN), and tests for solid (carbon, and trace metals) and liquid (water, fuels, glycol) contaminants. Today, the equipment used in these tests includes mass spectrometers, gas chromatographs, laser particle counters, and others.

Over the next several decades, enormous improvements were also made to internal combustion engines, lubricants, filtration systems, and the oil testing process. However, the problem of lubrication oil wastage has remained substantially unchanged primarily because of the practice of the “Fixed Change Interval” and to a lesser extent to the “Full Analysis” testing practice. The “Fixed Drain Interval” is still the dominant practice in all but a few continuous use IC engine applications. Because of these two practices, the benefits of the improvements to the IC engine, engine lubricants, and filters, have not been fully realized.

The few industries that use IC engines on a continuous basis have replaced the “fixed change interval” with an alternative process known the “Proactive Maintenance (PaM)” process. This process is based upon the following factors:
1. Cost effectiveness;
2. Routine, full analysis, laboratory testing with lubrication changes based on continued usability;
3. High efficiency oil filters (HEOF's) installed on each engine; and
4. Professional maintenance staff and equipment.
   With the above elements in place, the PaM process has safely extended the lubrication “change” interval many fold over the practice of the “fixed change interval” while still remaining cost effective. This practice has been adopted by industry segments with fleets of continuous use equipment such as over the road trucks, mining equipment, diesel generator sets, and the like.

This engine lubrication oil PaM practice has not been adopted for periodic use applications such as delivery trucks, garbage collection vehicles, school bus fleets, and least of all, privately owned automobiles. The barriers to adoption are well documented by a recent study entitled “Evaluation of High Efficiency Oil Filters in the State Fleet.” See, California Department of Toxic Substances Control.

The following were cited by the study as barriers to the adoption of PaM processes:
1. Increasing the complexity of the maintenance routine by introducing a second type of vehicle into the fleet, those with HEOF systems, and those without;
2. Adding routine lubrication oil testing to the maintenance workload;
3. Increasing the work and maintenance load with the installation of HEOFs on each vehicle;
4. Increasing the work and expense with additional inventory of spare parts and HEOFs;
5. Some engine manufacturers will void the warranties on the engines in the vehicles if aftermarket components are added by the end user; and
6. Having to put vehicles back into service while waiting for lubrication oil analysis results, and then needing to call the vehicle back in for an lubrication oil change if the analysis results deem it necessary, increasing costs and causing disruptions to the maintenance routine. Id.

The study clearly identifies the difficulties imposed on the maintenance departments by the addition of HEOFs to each vehicle. This approach increased the maintenance burden rather than reducing it, so there should be little wonder why only one fleet manager planned to continue using HEOFs after the California study was completed. In addition to those barriers cited in the study, in certain states, e.g., Ohio, modifications to a school bus must be state certified prior to installation, which makes the addition of HEOFs even more challenging. Id.

The automotive driving community can least of all justify a similar PaM lubrication oil program. The cost and complexity of lubrication oil testing along with the expense of a HEOF system for extending the change interval of 5-9 quarts of lubrication oil is just not practical. The prevailing attitude remains “It's much easier, cheaper, and safer to throw out the old lubrication oil and put in new lubrication oil every 3,000-5,000 miles, than risk the chance of ruining an engine.”

However, to make a PaM program feasible for periodic use IC engines a number of innovations must be achieved. The testing procedure has to be simplified, and yield immediate results. Presently, mounting and maintaining HEOFs on each vehicle cannot be cost justified. And finally the entire process must be highly automated to reduce labor expense and process errors. In general, the entire process must be less costly, less complex, and more user friendly, to be practical for the vast majority of vehicles.

Lubrication oil analysis, requiring multiple tests, has evolved into the “Accepted Practice” and is well documented as the means to determine if it is safe to extend the drain interval See, California Department of Toxic Substances Control, p. 28. This accepted practice is conducted on a periodic basis using a sample of lubrication oil extracted from the engine.

The sample is sent to a laboratory, subjected to a battery of tests, and the results are transmitted back to the maintenance department for interpretation, and only then lubrication maintenance activity can safely continue. The practice is cumbersome, expensive, time consuming (best turn-around of test results is approximately 48 hours), and error prone because of the complexity of the process. See, Paramo.

As mentioned, the “Full Analysis” testing practice evolved along with the evolution of various testing apparatus and methods. Because lubrication oil performs a number of secondary functions, several tests are required to determine if the lubrication oil can still fulfill all the intended functions. These tests can be categorized as “physical properties tests”, “chemical properties tests”, and “contaminant tests (liquid & solids)”. Under these main categories there are numerous individual tests. Under the “Full Analysis” testing practice if the lubrication oil has failed any of these tests the general practice is to drain/change the lubrication oil.

In addition to the aforementioned tests, there is an inexpensive chromatographic test that can also be used as an immediate screening tool for determining continued usability of lubrication oil. The formal name for this screening test is “Engine Oil Chromatographic Test” but is better known as the “Blotter Spot Test.” This test requires a single drop of used lubrication oil to be placed on the test media strip (that looks very much like an ink blotter) to form a spot and then a single drop of new lubrication oil is placed on the same test strip and a visual comparison is made to determine the condition of the used lubrication oil. A graphic chart of different oil spots is provided to help interpret or determine the results of the test. This test can screen for excessive amounts of both liquid and solid contaminants, depletion of additives, changes in viscosity, and other abnormal conditions that would require immediate attention. This simple, immediate, and inexpensive screening test was found to significantly reduce or eliminate catastrophic engine failures in passenger busses when integrated with off-site lubrication oil analysis. See, Trujillo.

Another less obvious requirement of “offline” lubrication oil maintenance, is the timely scheduling of the filtration process. Modern lubrication oil contains various beneficial additives, such as additives that reduce oxidation within an engine, and depletion of these additives must be monitored. The contaminants that neutralize these additives must be removed in a timely manner before they deplete all available additives. Certain contaminants act as catalysts, causing early depletion of certain additives. Other contaminants readily absorb water and should be removed to avoid depletion of other components in the additive package. And still other contaminants can keep anti-foaming agents from working properly. Older or legacy vehicles typically generate larger amounts of contaminants because of increase wear on internal components, and accordingly, should be filtered on a more frequent basis.

Diesel engine lubrication oil has a much higher surface tension and viscosity rating than many other types of fluids or lubricants. To allow contaminants and microscopic particles to escape suspension in diesel engine lubrication oil, they must first travel through this thick viscous fluid and overcome the strong interfacial barrier formed between the filter media and the surface of the lubrication oil. The means of causing this migration is molecular attraction. Heating the lubrication oil reduces its viscosity and reduces the force required to overcome the interfacial barrier between the filter media and the surface of the lubrication oil.

IN view of the foregoing considerations, there is a need for a lubrication oil filtration device that is highly automated and easy to use in order to induce use by vehicle maintenance staff. The device must also permit the rapid and accurate testing of the lubrication oil to determine if it can still be used, or must be replaced.

What is needed in these applications is a simple and efficient off-line method of “maintaining” lubricants, rather than “changing” them, that is external to the IC engine itself, which includes an instant means of assessing the quality of the lubrication oil. Such an off-line lubrication oil maintenance method is ideally suited for periodic use vehicles and engines. Such a device would use a process that mimics the operation of an on-line HEOF system, but that is located independently or off-line from the vehicle or engine. With such a device, it would be possible to safely extend lubrication change intervals in intermittent use IC engines by several fold.

### SUMMARY

According to aspects illustrated herein, there is provided an automated lubrication oil filtration device including an oil pump adapted to transfer a lubrication oil from an engine to an oil reservoir, an oil heater associated with the oil reservoir and adapted to increase a temperature of the lubrication oil, a filter pump adapted to transfer the lubrication oil from the oil reservoir through a filtering device and return the lubrication oil to the oil reservoir, and a programmable logic controller adapted to control operation of the oil pump, the oil heater, and the filter pump. The oil heater maintains the temperature of the lubrication oil at a desired temperature.

According to further aspects illustrated herein, there is provided a method for automatically filtering lubrication oil including transferring a lubrication oil from an engine to an oil reservoir using an oil pump, increasing a temperature of the lubrication oil using an oil heater, passing the lubrication oil through a filtering device using a filter pump, and returning the lubrication oil to the oil reservoir.

### BRIEF DESCRIPTION OF THE DRAWINGS

Various embodiments are disclosed, by way of example only, with reference to the accompanying drawings in which corresponding reference symbols indicate corresponding parts, in which:

FIG. 1 is a flowchart detailing an arrangement of an embodiment of a present automated lubrication oil filtration system; and

FIG. 2 is a schematic illustration of a further embodiment of a present automated lubrication oil filtration system.

### DETAILED DESCRIPTION

At the outset, it should be appreciated that like drawing numbers on different drawing views identify identical, or functionally similar, structural elements of the embodiments set forth herein. Furthermore, it is understood that these embodiments are not limited to the particular methodology, materials and modifications described and as such may, of course, vary. It is also understood that the terminology used herein is for the purpose of describing particular aspects only, and is not intended to limit the scope of the disclosed embodiments, which are limited only by the appended claims.

Unless defined otherwise, all technical and scientific terms used herein have the same meaning as commonly understood to one of ordinary skill in the art to which these embodiments belong. As used herein, the term “lubrication oil” comprises any fluid substance used, in whole, or in part, to reduce the friction between components of a machine. Lubrication oil may also serve other roles, such as a coolant, or a delivery mechanism for additives that are dissolved or suspended in the lubrication oil. As used herein, the terms “internal combustion engine,” “IC engine,” or “engine” comprise any of the class of apparatus that convert the heat energy of fuel to mechanical energy by combusting the fuel within the machine.

Moreover, although any devices, materials, and methods similar or equivalent to those described herein can be used in the practice or testing of these embodiments, some embodiments of devices, materials, and methods are now described.

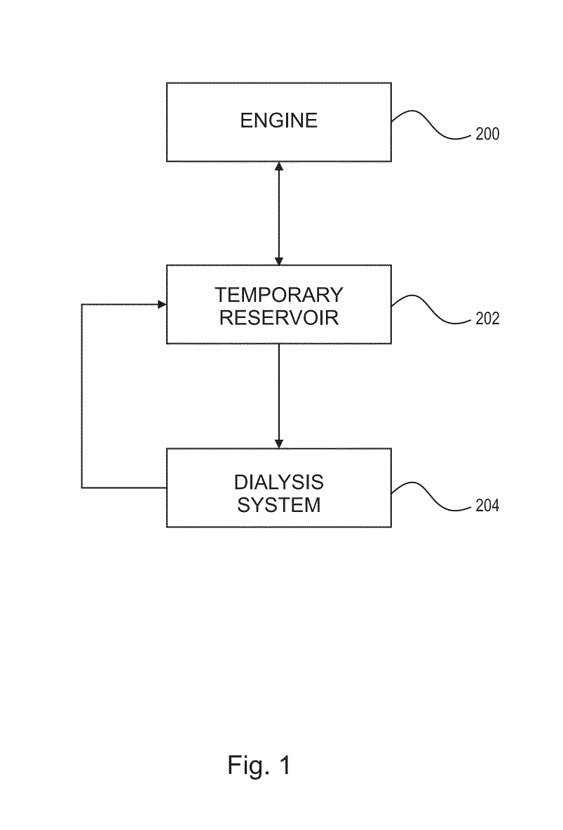

Referring now to the figures, FIG. 1 shows a schematic representing the path of lubrication oil during the operation of an embodiment of the invention, represented as a flowchart. Lubrication oil to be filtered begins in engine 200. Operation of the invention extracts this lubrication oil from engine 200 and transfers it to temporary reservoir 202. Once the lubrication oil has been completely transferred from engine 200 to temporary reservoir 202, the embodiment begins the filtration process by cycling the lubrication oil from temporary reservoir 202, through dialysis system 204, and back to temporary reservoir 202, at which point the filtration cycle begins again. These cycles, and thus, the filtration process, continue until a termination condition is reached.

The termination condition may comprise operating the invention for a preset time, either an absolute time, or a time calculated based on a factor such as lubrication oil volume or lubrication oil temperature. The termination condition may also be determined dynamically based on the condition of the lubrication oil. The filtration device may comprise a device or plurality of devices that assess the condition of the lubrication oil during the operation of the filtration device. The condition of the lubrication oil may comprise assessing the amount of one or more contaminants in the lubrication oil, carbon content of the lubrication oil, quantity of water in the lubrication oil, or quantity of additives in the lubrication oil. It will be appreciated by one of ordinary skill in the art that many factors and physical qualities of the lubrication oil may be relevant in determining the condition of the oil, and thus, the termination condition of the filtration process. After the termination condition is reached, the filtration device transfers all lubrication oil back to temporary reservoir 202 and transfers the filtered lubrication oil back to engine 200.

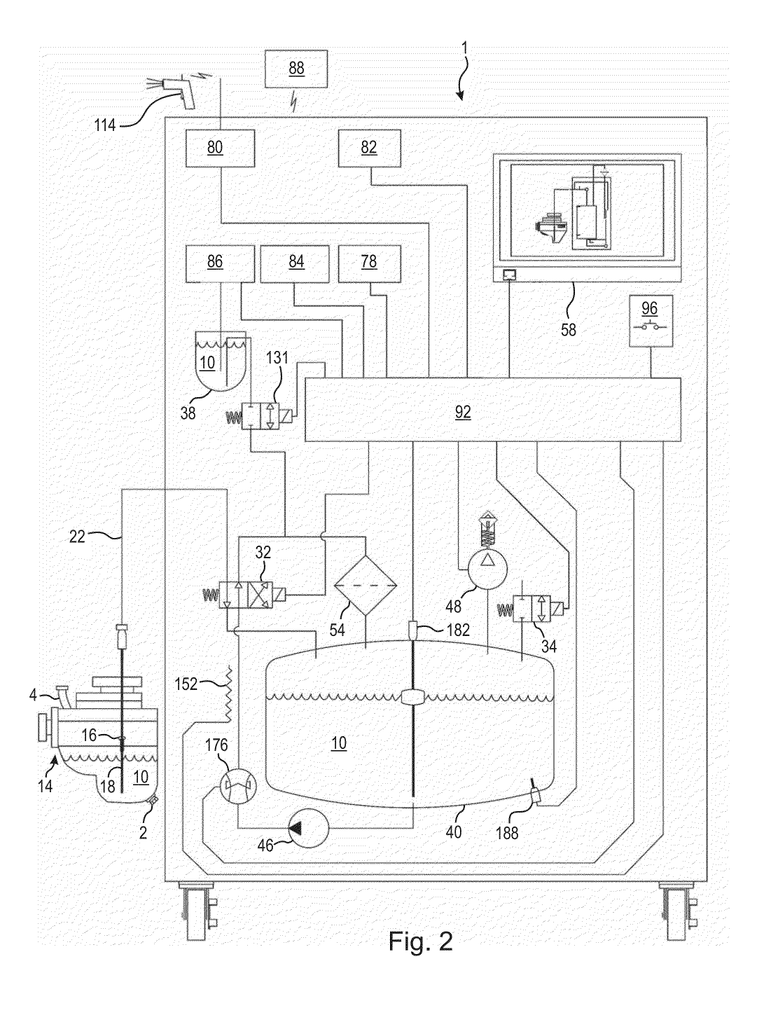

FIG. 2 is a schematic view of an embodiment showing various components of the invention. In the embodiment depicted, lubrication oil 10 has already been transferred to tank 40. This transfer is effected by inserting probe 18 into engine dipstick guide tube 16, oil fill tube 4, or by attaching an adapter nozzle to drain plug adapter 2.

Using human-machine interface (HMI) 58, the operator of filtration device 1 then enters the vehicle identification information, the hour or mileage reading of engine 14, and actuates filtration process start button 96. This starts the present filtration process. Because of the automated nature of filtration device 1, the operator does not need to be present or interact with filtration device 1 until the end of the process. Vacuum pump 48 creates a vacuum in tank 40 which extracts lubrication oil 10 from engine 14. This extraction continues until a loss of vacuum occurs, signaling that all lubrication oil 10 has been removed from engine 14. It should be appreciated that other types of pumps may also be used, e.g., a centrifugal pump, and such pumps fall within the scope of the claims.

When vacuum pump 48 used to extract lubrication oil 10 from engine 14 is turned off, the oil filtration timer is started, and after a delay, e.g., 15 seconds, filter pump 46 is started which then pumps lubrication oil 10 from tank 40 through flow meter 176, through filter 54, and finally back to tank 40. It should be appreciated that temporary reservoir 202 is equivalent to tank 40 and dialysis system 204 comprises filter pump 46, flow meter 176, filter 54, and the tubing connecting these components.

During the filtration portion of the process, lubrication oil heater 152 is enabled. Lubrication oil heater 152 may comprise a resistive type heater, though it should be appreciated that other types of heaters may also be used, and such heaters fall within the scope of the claims. In the specific embodiment of the invention shown in FIG. 2, lubrication oil heater 152 is proximate the tubing that carries lubrication oil 10 from tank 40 to filter 54, though it should be appreciated that other positions for lubrication oil heater 152 are possible, e.g., proximate tank 40, within tank 40, etc., and such positions fall within the scope of the claims. Lubrication oil heater 152 is used to maintain the temperature of lubrication oil 10 within a normal operating range for lubrication oil during the filtration process. Fluid temperature sensor 188 monitors the temperature of lubrication oil 10. If lubrication oil 10 exceeds the maximum safe operating temperature (fluid temperature sensor 188 sends a signal to the programmable logic controller (PLC) 92 causing filtration device 1 to shut down immediately, and posting a fault message to the “Status” window of HMI 58.

Heating lubrication oil 10 reduces its viscosity and surface tension so as to allow the least resistance to migration of the contaminants from lubrication oil 10 to filter 54. The design of filtration device 1 is based upon this phenomenon.

There are other implications involving viscosity and the offline processing of engine lubrication oil. Engine lubrication oil, like most oils, decreases in viscosity as it increases in temperature. The preferred means of “offline” processing starts by extracting the lubrication oil at normal engine operating temperature of approximately 190° F. with a viscosity of 8.0 Centistokes (cST). By the time the extraction process is completed a temperature drop of 50° F. or more can be experienced, resulting in a viscosity increase to 17 Centistokes. This temperature change during the transfer of the lubrication oil more than doubles the viscosity of the lubrication oil.

The implications of the change in viscosity are significant. If the lubrication oil is at operating temperature (190° F.), it takes about 15 minutes to extract 21 quarts through a dipstick probe. If the lubrication oil is at room temperature (68° F.), it takes several hours to extract the same amount of lubrication oil. Filter pump 46 is designed to efficiently circulate lubrication oil with a viscosity of 8.0 Centistokes. This allows the motor for filter pump 46 to be smaller and require less energy to operate. To efficiently filter lubrication oil 10, it should be extracted at operating temperature, and remain at operating temperature during the entire filtration process. Due to the natural loss of heat during the filtration process, lubrication oil 10 must be maintained at operating temperature artificially. Heat significantly reduces the viscosity and surface tension barriers, and increases the likelihood that contaminant particles will be transferred to the filter medium.

15W-40 Diesel engine lubrication oil is quite viscous, about 100 Centistokes at room temperature (68° F.). However, when heated to operating temperature (190° F.), the viscosity drops to 8.0 Centistokes. This heated, less-viscous lubrication oil 10 is pumped “past” the filter medium contained in filter 54 and not only “through” the filter medium contained in filter 54. In this process, contaminant particles are absorbed or trapped in filter 54 as they pass by and not necessarily through the filter medium. This medium is designed especially to retain particles after they have been intercepted. This process is known as “High Efficiency”, “Bypass”, or “Depth Type Filtration.” Typically, these types of filters have much larger dirt or contaminant holding capacities and continue cleaning the lubrication oil much longer than other filtration technologies.

These filters are constructed to allow about 1 gallon per minute of lubrication oil to pass by the filter media. Lubrication oil 10 continues to circulate through filter 54, getting cleaner with each additional pass. Circulating the dirty lubrication oil through this type of filtration system approximately 7 times, i.e., 7 cycles, has been found to yield optimal cleaning results when dealing with hydraulic fluids. However, it should be appreciated that greater or fewer circulation passes, or cycles, may also provide the desired level of filtration for the present filtration process.

The cleaning of fluids with low viscosity ratings, like hydraulic oil, is well known, and widely practiced by the use of high efficiency filters using both the online and offline methods. The cleaning of high viscosity oils is known for use in online applications, but heretofore is unknown for offline applications, due to the low rate of filtration of high viscosity lubrication oils.

Another objective of filtration device 1 is maintaining enough pressure to ensure the proper flow through filter 54 in order to adequately filter lubrication oil 10. If lubrication oil 10 is at the proper viscosity level, then a pump capable of supplying 1 gallon per minute (GPM) at 100 PSI is sufficient. Filter pump 46 has a built-in pressure regulator, that maintains lubrication oil pressure at 100 PSI, with an output of 1 GPM when the viscosity is 8 cST. However, if the viscosity of lubrication oil 10 increases, the flow decreases and the pressure remains the same. The end result is a decrease in flow, causing the filtration process to be less efficient.

The filter housing that holds the filter element has an internal by-pass circuit with fixed diameter orifice. This orifice allows 8 cST lubrication oil in excess of 1 GPM at 100 PSI to bypass the filter element.

In addition to removing particulate contaminants, as mentioned above, the high efficiency filter media designed for treating engine lubrication oil may comprise a secondary component that is capable of absorbing liquid contaminants such as water. One element of this additional component may comprise wood fiber that is capable of absorbing water through its cellular membranes. Very small amounts of water contamination in lubrication oil can lead to very rapid engine failure if left unchecked.

Lubrication oil 10 continues to circulate until a termination condition is reached. When that happens, filter pump 46 is stopped, oil return solenoid valve 32, which is also known as a return valve, is actuated which causes filtration device 1 to enter a lubrication oil return mode. In other words, actuation of valve 32 forms a path from tank 40, through pump 46, flow meter 176, and valve 32, to engine 14, i.e., the oil return path.

Upon receipt of a signal by PLC 92, it initiates oil return mode, and posts a message to the “Status” window of the HMI 58 that the system is in lubrication oil return mode. First, PLC 92 sends a signal to air solenoid valve 34 thereby venting tank 40 to the atmosphere so that the volume of oil 10 removed from tank 40 during lubrication oil return mode is replaced by air so that a vacuum is not formed. PLC 92 then sends a signal to restart the filter pump 46 and lubrication oil 10 is returned to engine 14 through probe hose 22. As the lubrication oil is pumped from tank 40, PLC 92 receives data about the level of lubrication oil 10 in tank 40 from level gauge 182. When level gauge 182 indicates that tank 40 is empty, a “down count” timer is started. This timer is set such that when the pre-determined time elapses, all lubrication oil 10 has been removed from tank 40, and PLC 92 stops filter pump 46 and de-actuates solenoid valve 34 thereby closing the tank to atmospheric air entry.

Filtration device 1 may also comprise a device for automatically testing lubrication oil 10 before it is returned to engine 14. Lubrication oil 10 is pumped from tank 40 through oil return solenoid valve 32 then through sample solenoid valve 131 to oil sample reservoir 38 until oil sample reservoir 38 is properly filled. In this configuration, solenoid valve 32 is activated. A test will be conducted on lubrication oil 10 by the fluid identification sensor 86. Fluid identification sensor 86 may comprise the devices described in U.S. Pat. Nos. 6,931,926 and 7,895,890. Alternatively, fluid identification sensor 86 may comprise one or more of a dielectric sensor, a capacitive sensor, a permittivity sensor, and other sensors well known in the art. Such integrated testing capability could provide an alternative solution to the existing off-site lab testing practice, and thus reduce or eliminate one of the major obstacles to adopting an offline lubrication oil PaM process. In addition to the automatic testing methods mentioned above, a simple and inexpensive manual blotter test could be incorporated to provide screening for the most common sources of catastrophic engine failure, such as fuel dilution, glycol contamination, and excessive soot load. Upon completion of the test by fluid identification sensor 86, lubrication oil 10 will either be returned to engine 14 or determined to meet a predefined failure condition, such as excessive soot load, and not allowed to be returned to engine 14. A message is then posted to HMI 58 stating the results of the lubrication oil test. Example messages include but are not limited to: “Oil No Longer Useable,” or an estimate of useful oil life remaining for lubrication oil 10, such as: “50% Oil Life Remaining”

As described above, when lubrication oil 10 is completely pumped back to engine 14, filter pump 46 stops pumping, lubrication oil return solenoid valve 32 is de-actuated, which shifts it back to the position used during the filtration process, and the filtration process complete message is posted to HMI 58. A new filtration record is created and an index number is assigned to it. This filtration record may comprise, for example, a unique record number, the vehicle identification number, the number of miles on the vehicle, the length of time the lubrication oil was filtered, and the date. If there were any fault conditions encountered during the process they will be posted to HMI 58. A new filtration process will not start until all the “Faults” listed on HMI 58 have been reset or resolved.

A wireless scanner 80 and handheld scanner unit 114 may also be used in conjunction with filtration device 1 in order to save the operator from having to manually enter data into the database of lubrication oil and engine information stored in the internal memory of filtration device 1. Wireless scanner 80 and handheld scanner unit 114 may comprise a bar code scanner, or a wireless card reader, or even a communication scanner talking directly to the vehicle containing the lubrication oil to be filtered. For example, it may communicate with the vehicle directly by downloading the mileage or hours reading directly from the engine control module, or other pertinent information.

A remote computer 88 could also be used in conjunction with the present system in order to transfer filtration records, test data, and other data from remote computer 88 to the internal memory of the present system, or vice versa. A wireless data connection provided by wireless modem 82 would allow the embodiment to communicate with, and access data through, remote computer networks, including the Internet. Such communication may comprise automatically sending e-mails to a support center requesting consumable parts such as filter elements, or test parameters for certain types of lubrication oil, including allowing a service center to remotely troubleshoot any problems.

Filtration device 1 may also include a point of sale terminal 84 to permit the present system to function in a fully autonomous, kiosk arrangement. Such an arrangement could be used in overnight parking structures where a vehicle would be parked overnight and have its lubrication oil filtered while parked. The owner of the vehicle would interact with HMI 58 and point of sale terminal 84 to pay for and initiate the filtration process. Upon completion of this process, printer 78 would print a filtration report and a receipt. Printer 78 could also be used to print stored filtration records and prepare forms to be completed by vehicle owners or fleet managers.

It should be appreciated that the various connections depicted in contact with PLC 92 are intended to show the interaction of various system components, e.g., wireless scanner 80 and point of sale terminal 84 with PLC 92. One of ordinary skill in the art will appreciate that the nature and type of the connection depends on the nature of the component and its associated data transfer means, e.g., low voltage DC signals.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

Parts List

| | |
|---|---|
| 1 | filtration device |
| 2 | drain plug adaptor |
| 4 | oil fill tube |
| 10 | lubrication oil |
| 14 | engine |
| 16 | dip stick guide tube |
| 18 | probe |
| 22 | probe hose |
| 32 | oil return solenoid valve |
| 34 | air solenoid valve |
| 38 | sample reservoir |
| 40 | tank |
| 46 | filter pump |
| 48 | vacuum pump |
| 54 | filter |
| 58 | human-machine interface |
| 78 | printer |
| 80 | wireless scanner |
| 82 | wireless modem |
| 84 | point of sale terminal |
| 86 | fluid identification sensor |
| 88 | remote computer |
| 92 | programmable logic controller |
| 96 | filtration process start button |
| 114 | handheld scanner unit |
| 131 | sample solenoid valve |
| 152 | lubrication oil heater |
| 176 | flow meter |
| 182 | level gauge |
| 188 | fluid temperature sensor |
| 200 | engine |
| 202 | temporary reservoir |
| 204 | dialysis system |

What I claim is:

1. An automated lubrication oil filtration device comprising:
an oil pump adapted to transfer a lubrication oil from an engine to an oil reservoir;
an oil heater associated with the oil reservoir and adapted to increase a temperature of the lubrication oil;
a filter pump adapted to transfer the lubrication oil from the oil reservoir through a filtering device and return the lubrication oil to the oil reservoir; and
a programmable logic controller adapted to control operation of the oil pump, the oil heater, and the filter pump,
wherein the oil heater maintains the temperature of the lubrication oil at a desired temperature.

2. The automated lubrication oil filtration device of claim 1 wherein the oil pump is a vacuum pump.

3. The automated lubrication oil filtration device of claim 1 wherein the programmable logic controller is adapted to stop the filter pump upon satisfaction of at least one termination condition.

4. The automated lubrication oil filtration device of claim 3 wherein the at least one termination condition is selected from the group consisting of: an elapsed time, a number of filtration cycles, and combinations thereof.

5. The automated lubrication oil filtration device of claim 1 further comprising a temperature sensor adapted to measure the temperature of the lubrication oil and activate and deactivate the oil heater to maintain the temperature of the lubrication oil at the desired temperature.

6. The automated lubrication oil filtration device of claim 1 further comprising a return valve wherein the return valve is adapted to allow the filter pump to transfer the lubrication oil from the oil reservoir to the engine.

7. The automated lubrication oil filtration device of claim 6 wherein the lubrication oil is transferred from the oil reservoir by the filter pump through the return valve prior to passing through the filtering device or after flowing through the filtering device.

8. The automated lubrication oil filtration device of claim 1 further comprising a fluid identification sensor adapted to measure at least one characteristic of the lubrication oil.

9. The automated lubrication oil filtration device of claim 8 wherein the at least one characteristic is selected from the group consisting of: lubricity, permittivity, capacitance, and combinations thereof.

10. The automated lubrication oil filtration device of claim 8 further comprising a return valve wherein the programmable logic controller is adapted to actuate the return valve upon receiving a signal from the fluid identification sensor, the signal comprising an indication that the at least one characteristic reached a predefined threshold.

11. The automated lubrication oil filtration device of claim 8 further comprising a return valve wherein the programmable logic controller is adapted to identify a failure condition of the lubrication oil based on the at least one characteristic and prevent actuation of the return valve.

12. The automated lubrication oil filtration device of claim 1 further comprising a scanner wherein the engine further comprises at least one oil identification marking and the scanner is adapted to read the at least one oil identification marking and to transmit an oil identification to the programmable logic controller.

13. A method for automatically filtering lubrication oil comprising:
transferring a lubrication oil from an engine to an oil reservoir using an oil pump;
increasing a temperature of the lubrication oil using an oil heater;
passing the lubrication oil through a filtering device using a filter pump; and
returning the lubrication oil to the oil reservoir.

14. The method recited in claim 13 wherein the steps of passing the lubrication oil through the filtering device using the filter pump and returning the lubrication oil to the oil reservoir are repeated at least twice.

15. The method recited in claim 13 wherein the temperature of the lubrication oil is measured by a temperature sensor and the lubrication oil is heated using the oil heater to maintain the temperature of the lubrication oil at a desired temperature.

16. The method recited in claim 13 further comprising transferring the lubrication oil from the oil reservoir to the engine.

17. The method recited in claim 16 wherein the lubrication oil is transferred from the oil reservoir to the engine through a return valve using the filter pump.

18. The method recited in claim 13 further comprising measuring at least one characteristic of the lubrication oil using a fluid identification sensor.

19. The method recited in claim 18 further comprising preventing the transfer of the lubrication oil from the oil reservoir to the engine after the at least one characteristic reaches a failure condition.

20. The method recited in claim 18 wherein the steps of passing the lubrication oil through the filtering device using the filter pump and returning the lubrication oil to the oil reservoir are repeated until the at least one characteristic reaches a predefined threshold.

21. The method recited in claim 19 further comprising transferring the lubrication oil from the oil reservoir to the engine after the at least one characteristic reaches the predefined threshold.
